(19) United States
(12) Patent Application Publication
(10) Pub. No.: US 2015/0324810 A1
(43) Pub. Date: Nov. 12, 2015

(54) PERSONAL UNIVERSAL PROFILE

(71) Applicants: Sundar Amalan Vincent, San Jose, CA (US); Mark Delun Yuan, San Mateo, CA (US)

(72) Inventors: Sundar Amalan Vincent, San Jose, CA (US); Mark Delun Yuan, San Mateo, CA (US)

(73) Assignee: EBAY INC., SAN JOSE, CA (US)

(21) Appl. No.: 14/272,089

(22) Filed: May 7, 2014

(51) Int. Cl. G06Q 30/02; G06Q 30/06

(52) U.S. Cl. CPC G06Q 30/0201; G06Q 30/0269; G06Q 30/0601

(57) ABSTRACT

A method and a system for creating, updating and processing a universal profile which includes an aggregation of previous transaction with multiple, distinct transaction entities. A universal profile (UP) manager creates a universal profile for an account. The universal profile comprises transaction data based on an aggregate of transactions with multiple, distinct transaction entities. The UP manager receives a universal profile preference indicating whether at least a portion of the transaction data is to be shared. The UP manager provides the transaction data to a particular transaction entity according to the universal profile preference. The UP manager receives, from the particular transaction entity, a transaction context comprising at least a portion of a transaction customized based on transaction data shared according to the universal profile preference.

### TECHNICAL FIELD

The present application relates generally to the technical field of computerized transaction and, in one specific example, to aggregation of profile data for use in transactions with distinct transaction entities.

### BACKGROUND

Many conventional computing contexts involve the use of a user profile, in which a computer system retains a set of information for an account. In many such conventional contexts, a server maintains an account for a specific individual. The account can be associated with, for example, a retailer from which the specific individual makes frequent purchases. The retailer implements the account to store the specific individual's payment information and records of transactions between the retailer and the specific individual. By maintaining the records of transactions, the retailer identifies purchasing habits and patterns of the specific individual and can use the identified habits and patterns to incentivize the specific individual to make future purchases.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment of a universal profile manager may be deployed, according to some embodiments of the invention.

FIG. 2 is a high-level entity-relationship diagram, illustrating various modules created (and updated) by the universal profile manager and maintained within a database(s), according to some embodiments of the invention.

FIG. 3 is a diagram illustrating a 3^{rd} Party universal profile manager application creating a transaction context based on shared transaction data, according to some embodiments of the invention.

FIG. 4 is a flow diagram illustrating an example of the method operations involved in a method of a universal profile manager sharing transaction data to a particular transaction entity according to universal profile preferences of a universal profile associated with an account, according to some embodiments of the invention.

FIG. 5 is a flow diagram illustrating an example of the method operations involved in a method of a transaction entity creating a transaction context based on transaction data shared according to universal profile preferences of a universal profile associated with a remote account, according to some embodiments of the invention.

FIG. 6 shows a diagrammatic representation of machine in the example form of a computer system within which a set of instructions, for causing the machine to perform any one or more of the methodologies discussed herein, may be executed.

### DETAILED DESCRIPTION

Example methods and systems for a universal profile manager are described. In the following description, for purposes of explanation, numerous specific details are set forth in order to provide a thorough understanding of example embodiments. It will be evident, however, to one skilled in the art that the present invention may be practiced without these specific details.

The universal profile (UP) manager provides for a universal profile associated with an account. The account may correspond to a user. In one embodiment, the account may be maintained (e.g., stored) on a user device, such as a wireless mobile device. The universal profile includes an aggregate of information associated with a user that may be shared with multiple retailers. The information may include but is not limited to preferences of a user, transactions between a user and one or more retailers, online and offline interactions between a user and one or more retailers, personal information about a user, and generally, user activities, such as a history of a user (e.g., a history of user locations visited, a history of search queries generated by a user, etc.). The universal profile includes preferences indicating how (or if) the funded account prefers to share information about the transactions with retailers.

In some embodiments, as the account proceeds with a transaction with a particular retailer, the UP manager shares information with the particular retailer according to the preferences. In some embodiments, a user of the account may have the option of instructing the UP manager to selectively share part or all of the information with the particular retailer. The particular retailer can use the shared information to customize aspects of the transaction with the account. For example, the particular retailer can offer a deal, a type of product or a type of service that is similar to a transaction(s) in the shared information. According to another example, the particular retailer can infer a deal, product or service the account would most likely purchase (or not purchase) based on a transaction(s) in the shared information. In another example, the particular retailer may customize the presentation of information to the user based on the shared information.

As opposed to conventional systems, the UP manager allows the account to decide—in some embodiments, via the universal profile's preferences—how, if and when information about past transactions (and additional data from the universal profile) with a wide variety of retailers is shared with a particular retailer—even if the account has never previously interacted with the particular retailer. The universal profile, in some embodiments, such additional data can be, but is not limited to, information regarding a user of the account's likes, dislikes, allergies, preferred brands, preferred product categories (e.g. luxury, thrifty, gourmet), etc.

When such information is shared, the UP manager allows a retailer(s) to identify data, such as an offer (e.g., a coupon, a discount, a credit, an award, a transaction, a voucher, a token, an advertisement, a certificate, a recommendation), information (e.g., retailer information, product information, service information), a good or a service, that should—or should not—be offered to the account. In some embodiments, the retailer(s) may use the information shared to identify the data to be offered to the account. In other embodiments, the retailer(s) may use the information shared in combination with data about the user or the account maintained by the retailer's own system or a third party system. The UP manager thereby provides the account with control over the extent to which information is shared with different retailers. The UP manager also provides the advantage of assisting retailers to identify transactions suitable for the account based on the kind of information the account has opted to share with retailers.

### Platform Architecture

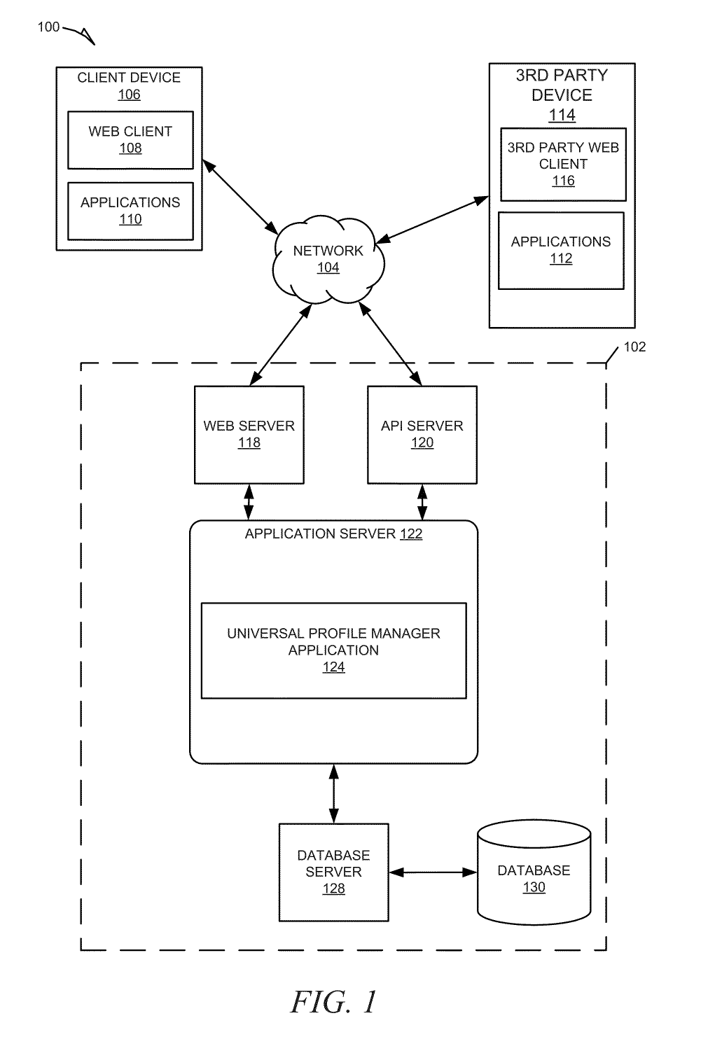

FIG. 1 is a network diagram depicting a client-server system 100, within which one example embodiment of a universal profile manager may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 108 (e.g., a browser, such as the Internet Explorer browser developed by Microsoft Corporation of Redmond, Wash. State) and a client application(s) 110 executing on a client device 106. It is understood that the client device(s) 106 may be a personal computer (PC), a tablet PC, a set-top box (STB), a Personal Digital Assistant (PDA), a cellular telephone, a web appliance, a network router, switch or bridge, a tablet computer, a wearable computing device, a computing device embedded in clothing or an accessory or any machine capable of executing a set of instructions (sequential or otherwise) that specify actions to be taken by that machine. Further, while only a single device is illustrated, the terms “device” and “machine” shall also be taken to include any collection of devices (or machines) that individually or jointly execute a set (or multiple sets) of instructions to perform any one or more of the methodologies discussed herein.

FIG. 1 also illustrates, for example, a 3^{rd} Party Device(s) 114 that executes a web client 116 and an application(s) 112. In some embodiments, a 3^{rd} Party can be a transaction entity (such as a retailer) processing a transaction with an account associated with the client device 106. It is understood that the 3^{rd} Party Device can (but is not limited to) be a point-of-sale device, a handheld wireless mobile devices, a server(s), a sensor(s) (such as beacons—e.g., Bluetooth or RF-enabled sensors), a Wifi-enabled device, a camera and/or a scanner (e.g., barcode scanners).

An Application Program Interface (API) server 120 and a web server 118 are coupled to, and provide programmatic and web interfaces respectively to, an application server(s) 122. The application server 122 hosts a universal profile manager application 124. The application server 122 is, in turn, shown to be coupled to a database server(s) 128 that facilitates access to a database(s) 130. In some embodiments, the web client 106 and the 3^{rd} Party Device 114 may access the universal profile manager application 124 via a web server 116.

The universal profile manager application 124 may provide a number of universal profile functions and services to accounts and transaction entities (such as retailers) that access the networked system 102. While the universal profile manager application 124 is shown in FIG. 1 to form part of the networked system 102, it will be appreciated that, in alternative embodiments, the universal profile manager application 124 may form part of a system or service, such as a payment service, that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. Any portion, or portions, of the universal profile manager 124 may reside and be executed from a client device, such as a wireless mobile device, or a point-of-sale device. The universal profile manager application 124 could also be implemented as standalone software program(s), which does not necessarily have networking capabilities.

### Data Structures

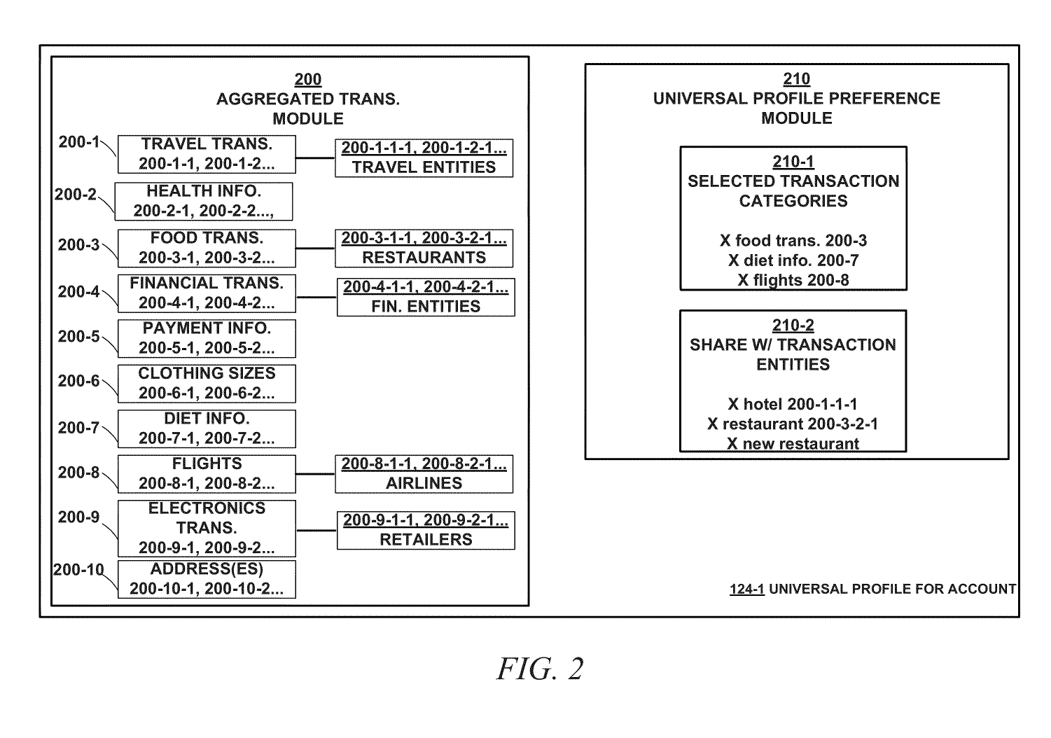

FIG. 2 is a high-level entity-relationship diagram, illustrating various modules 200, 210 created (and updated) by the UP manager 124 and maintained within a database(s) 130, according to some embodiments of the invention. The modules 200, 210 are associated with a universal profile of an account.

The UP manager 124 creates and updates an aggregated transaction module 200 for the universal profile of the account. The UP manager 123 aggregates records of transactions between the account and multiple, distinct transaction entities along with records storing data directly provided by the account. The aggregated transaction module 200 includes an aggregation of the following transactions: travel transactions 200-1-1, 200-1-2 . . . (hotel transactions, travel expenses, etc.) between the account and respective travel entities 200-1-1-1, 200-1-2-1 . . . (hotels, car rental companies, etc.), food transactions 200-3-1, 200-3-2 . . . (meal purchases, etc.) between the account and respective restaurants 200-3-1-1, 200-3-2-1, financial transactions 200-4-1, 200-4-2 . . . (banking transactions, credit card statements, etc.) between the account and respective financial services entities 200-4-1-1, 200-4-2-1, flight purchases 200-8-1, 200-8-2 . . . between the account and respective airlines 200-8-1-1, 200-8-2-1 . . . . It is understood that the aggregated transaction module 200 can include transactions between the account and various other types of transaction entities.

The UP manager 123 also aggregates records that include information provided directly to the account, such as: health information 200-2-1, 200-2-2 . . . (medications, medical history, health insurance information. etc.), payment information, 200-5-1, 200-5-2 . . . (bank accounts, credit card numbers, account funding, etc.), clothing sizes 200-6-1, 200-6-2, diet information 200-7-1, 200-7-2 . . . (vegetarian, food allergies, etc.), and address information 200-10-1, 200-10-2 . . . (shipping address, billing address, home address, etc.). It is understood that the aggregated transaction module 200 can include various other types of information provided directly to the account.

The UP manager 124 creates and updates a universal profile preference module 200 for the universal profile of the account. The universal profile preference module 200 indicates categories of transaction and/or transaction entities that can receive portions of the aggregated transactions in the aggregated transaction module 200. The universal profile preference module 200 includes selected transaction categories 210-1 that indicate which type of data from the aggregated transaction are to be shared with specified transaction entities 210-2. In some embodiments, any data, from individual pieces of data to categories of data, maintained by the UP manager 124 may be selected by a user for sharing with any third party entity.

As illustrated in FIG. 2, the universal profile preference module 200 indicates that the account shares food transactions 200-3, diet information 200-7 and flight information 200-8 whenever becoming involved or prospectively involved in a transaction with a particular hotel 200-1-1-1, a particular restaurant 200-3-1-1 and when becoming involved or prospectively involved in a transaction with a restaurant for the first time (“new restaurant”). All other transaction data in the aggregated transaction module 200 will not be shared with the particular hotel 200-1-1-1, the particular restaurant 200-3-1-1 and any new restaurant.

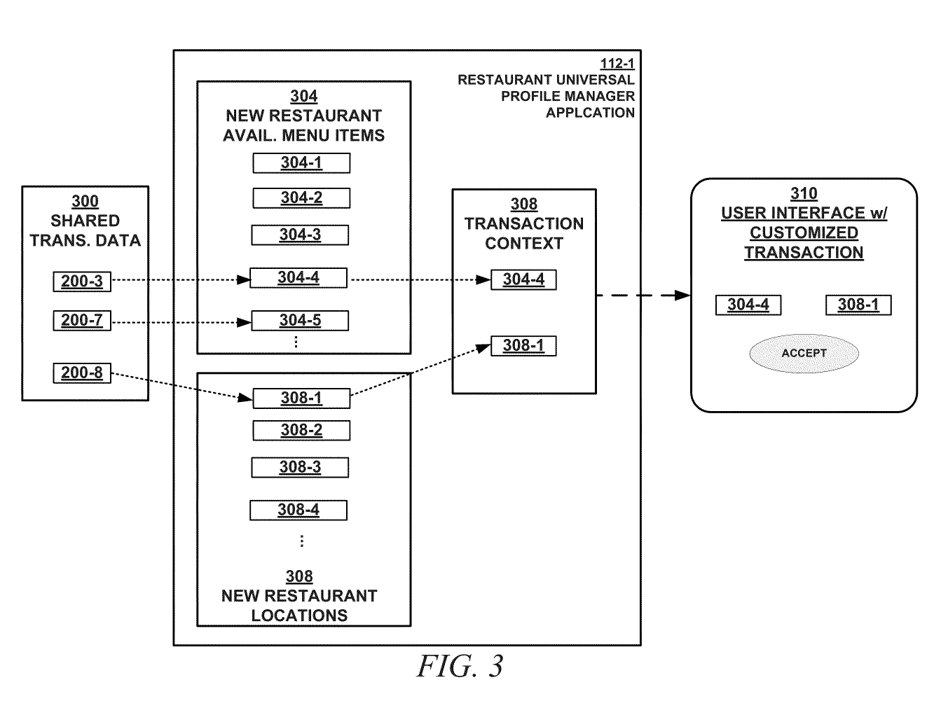

FIG. 3 is a diagram illustrating a 3^{rd} Party universal profile manager application 112-1 creating a transaction context 308 based on shared transaction data 300, according to some embodiments of the invention. In various embodiments, a 3^{rd} Party UP manager application 112-1 can be associated with a restaurant, which detects the presence of a mobile device associated with an account. The mobile device associated with the account can also detect the UP manager application 124. Based on such detection, the UP manager application 124 communicates with the mobile device and sends shared transaction data 300 via the mobile device to the 3^{rd} Party UP manager application 112-1. In one embodiment, a wireless mobile device detects, via Global Positioning System (GPS) data, that it is within a certain distance of a 3rd Party device. Based on such detection, the wireless mobile device initiates sharing of at least a subset of the universal profile with the 3rd Party device Detection can occur according to other various approaches. For example, in various embodiments, the detection of proximity between a client device and the 3rd Party device occurs via Beacon (e.g., a Bluetooth low energy-enabled device), or the client device logs onto a network on which the 3rd Party device is logged on, or a user of the client device “checks in” via a location-based services application (e.g., Facebook, Foursquare, etc.). It is understood that sharing of at least a subset of the universal profile occurs, in some embodiments, upon the client device receiving an affirmative action, such as a confirmation, by a user of the client device. Such sharing can also occur based on receiving real-time manual selections, from a user of the account, of various subsets of the universal profile that are to be shared with a 3^{rd} Party device.

As previously illustrated in FIG. 2, the shared transaction data 300 includes food transactions 200-3, diet information 200-7 and flight information 200-8. It is understood that, in various embodiments, the UP manager application 124 can also reside on and be executed from the mobile device.

The 3^{rd} Party UP manager application 112-1 receives the shared transaction data 300. The restaurant is a “new” restaurant in that it has never previously completed a transaction with the account. The 3^{rd} Party UP manager application 112-1 has a module representing a menu 304 with various menu items 304-1, 304-2, . . . 304-5 . . . . The 3^{rd} Party UP manager application 112-1 also has a listing 308 of multiple locations 308-1, 308-2, . . . 308-4 . . . of the new restaurant. The 3^{rd} Party UP manager application 112-1 processes the shared transaction data 300 against the menu 304 and listing 308 in order to create a transaction context 308 for the account.

The 3^{rd} Party UP manager application 112-1 identifies a menu item 304-4 similar to a type of food in the food transactions 200-3 in the shared transaction data 300. The diet information 200-7 includes a description of a food allergy. The 3^{rd} Party UP manager application 112-1 identifies a menu item 304-5 that is incompatible with the food allergy. The flight information 200-8 includes a description of an upcoming flight reservation to a particular city. The 3^{rd} Party UP manager application 112-1 identifies a restaurant location 308-1 in that particular city. The 3^{rd} Party UP manager application 112-1 processed the similar menu item 304-4 and a description of the restaurant location 308-1 to create a transaction context 308, such as a coupon to purchase the menu item 304-4 at the restaurant location 308-1. The incompatible menu item 304-5 is not included in the transaction context 308 due to the food allergy.

The 3^{rd} Party UP manager application 112-1 creates user interface data based on the transaction context 308. The 3^{rd} Party UP manager application 112-1 sends the user interface data to a display device for display via a user interface 310. In another embodiment, the user interface data can be sent to the mobile device (or any client device associated with the account) for display on the mobile device.

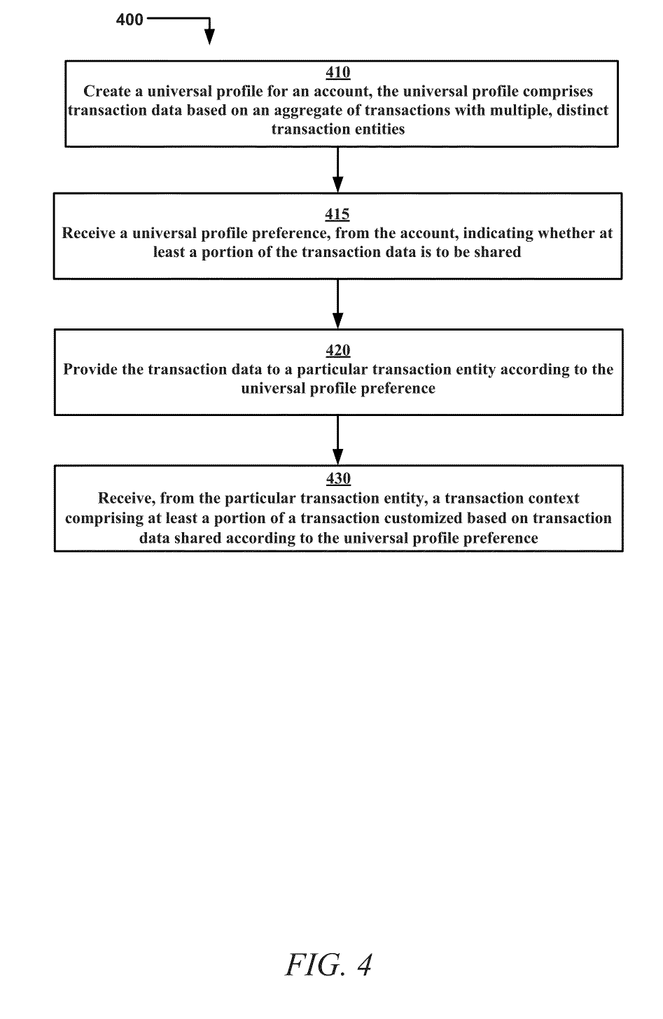

FIG. 4 is a flow diagram 400 illustrating an example of the method operations involved in a method of a universal profile manager sharing transaction data to a particular transaction entity according to universal profile preferences of a universal profile associated with an account, according to some embodiments of the invention.

At step 410, the UP manager 124 creates a universal profile for an account. The universal profile comprises personal data associated with a user of the account and transaction data based on an aggregate of transactions with multiple, distinct transaction entities (and/or any other kind of entity). In various embodiments, the transaction data may include purchase information, purchase history information, method of payment information, payment amount information, payment account information, address information, purchased item(s) information and shipping information. In some embodiments, the transaction data may include information about transaction that were partially completed, transactions that started but eventually were not completed, declined transactions and transactions saved for completion at a time in the future (such as via a wishlist functionality).

The personal data associated with the user of the account may include any type of data provided by the account, such as: health information, medical information, diet information, and an indication(s) of preferences as to what kind of services, products and retailers are preferred by the account.

It is noted that the transaction data in the universal profile may also include dynamically created trends and inferred data as the universal profile acquires and aggregates profile data and transaction data. Such trends can be includes in the universal profile to indicate, for example, preferred brands, preferred retailers, data about the frequency of various actions taken by the user of the account and a history profile of actions taken by the user of the account.

It is understood that, in various embodiments, the universal profile can be stored and maintained on a client device—such as a wireless mobile device. In such a scenario, the wireless mobile device transmits the universal profile (or a subset of the universal profile that is to be shared with an entity) to the UP manager 124. The UP manager 124 receives and processes the universal profile (or the subset of the universal profile) in order to share data with a 3rd Party system. It is further understood that, in various embodiments, the universal profile (or any subset of the universal profile) can be stored in a secure element of the a client device, stored by the UP manager 124 on a server(s) machine or in a cloud computing environment. It is further noted that the universal profile (or any subset of the universal profile) can be encrypted in order to allow for secure storage and/or transmission.

At step 415, the UP manager 124 receives a universal profile preference, from the account, indicating whether at least a portion of the transaction data is to be shared. In various embodiments, the UP manager 124 receives a selection of a category of transactions and receives a preference to share a portion of transaction data with any transaction entity that offers transactions included in the category of transactions.

For example, the UP manager 124 receives an indication that the account selects transactions relating to a health information category (such as food allergies). A preference is received by the UP manager 124 to share transaction data that includes information about food allergies to particular transaction entities that serve food (such as restaurants).

At step 420, the UP manager 124 provides the transaction data to a particular transaction entity according to the universal profile preference. It is understood that a preference to share transaction data can be related to any kind of information category (or type of information) and such a preference can indicate that transaction data in a selected information category should (or shouldn't be) be shared with various transaction entities.

At step 425, the UP manager 124 receives, from the particular transaction entity, a transaction context comprising at least a portion of a transaction customized based on transaction data shared according to the universal profile preference. In various embodiments, the UP manager receives a transaction customized by a transaction entity to be similar to a transaction upon which shared transaction data is based.

For example, in various embodiments, the universal profile preference indicates the account prefers to share transaction data related to previous travels with any transaction entity that offers travel services (e.g. hotels, airlines, resorts, transportation services, etc.). If the account is entering into a transaction with a hotel for the first time (“new hotel”), the new hotel can use the shared transaction data to identify a type of hotel room and rate the account purchased during previous travels. The new hotel creates a transaction context which, for example, can be an offer for similar hotel rooms and similar rates from previous travels.

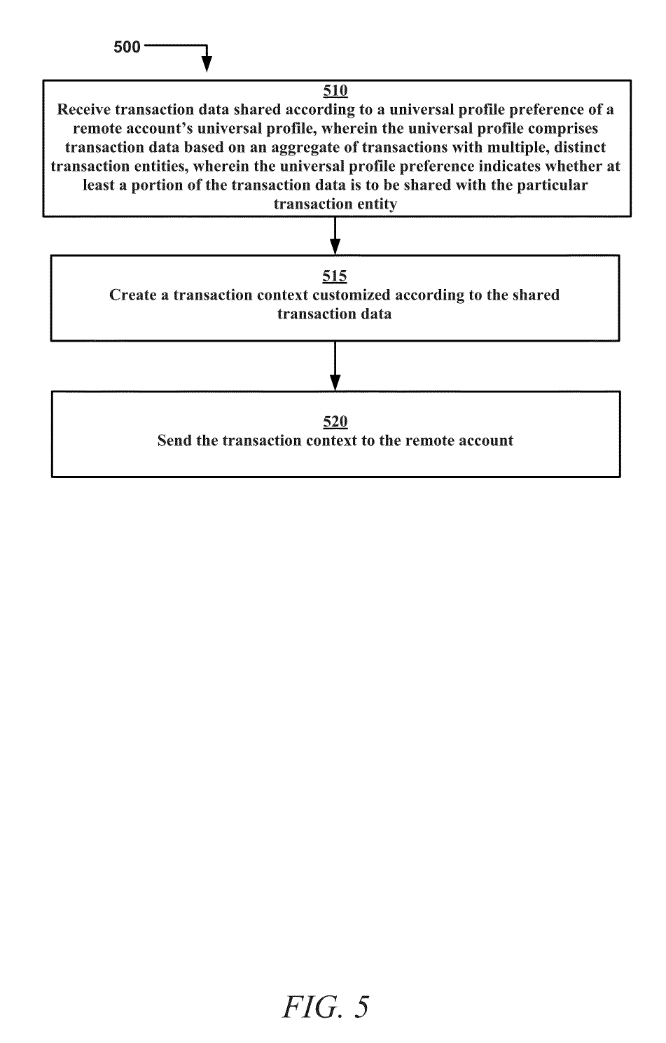

FIG. 5 is a flow diagram 500 illustrating an example of the method operations involved in a method of a transaction entity creating a transaction context based on transaction data shared according to universal profile preferences of a universal profile associated with a remote account, according to some embodiments of the invention.

At step 510, particular transaction entity receives a portion of transaction data shared according to a universal profile preference of a remote account's universal profile, wherein the universal profile comprises transaction data based on an aggregate of transactions with multiple, distinct transaction entities. The universal profile preference indicates whether at least a portion of the transaction data is to be shared with the particular transaction entity.

At step 515, the particular transaction entity creates a transaction context customized according to the shared transaction data. For example, in various embodiments, the universal profile preference indicates the account prefers to share transaction data related to previous electronics purchases with various types of retailers. If the account is entering into a transaction with an electronics retailer for the first time (“new retailer”), the new retailer can use the shared transaction data to identify an electronics accessory that is compatible with at least one of the electronics that were previously purchased. The new retailer creates a transaction context customized to include an offer for a compatible electronics accessory.

At step 520, the particular transaction entity sends the transaction context to the remote account.

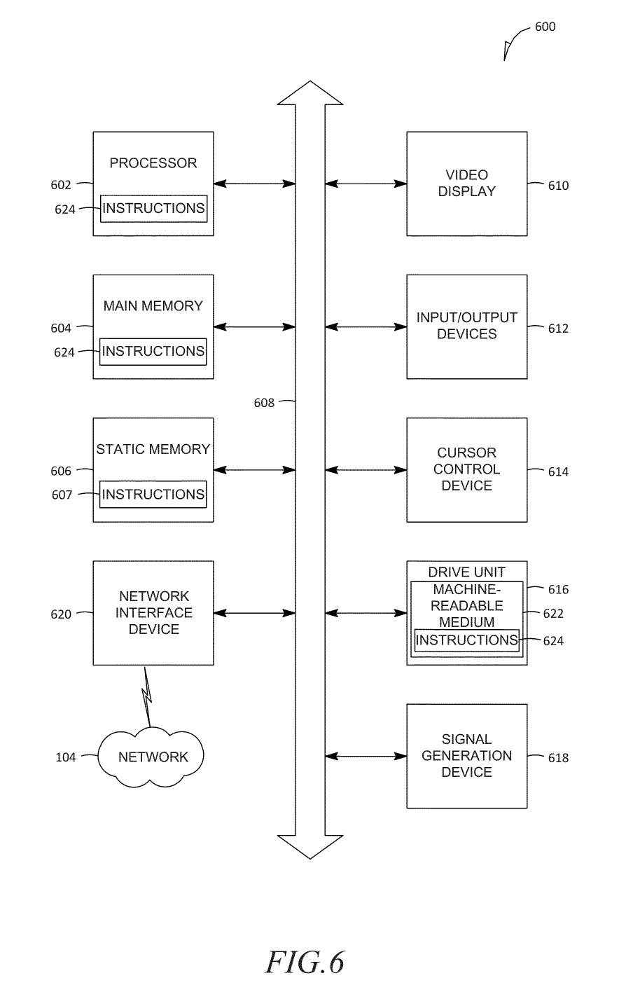

FIG. 6 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606 (with one or more sets of instructions 607) which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions 624 (e.g., software) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 104 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method(s) and system(s) to create a universal profile, share transaction data according to universal profile preferences and create a customized transaction context according to the shared transaction data have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer system comprising:
a processor;
a memory device holding an instruction set executable by the processor to cause the computer system to perform operations comprising:
creating a universal profile for an account, the universal profile comprising profile data about a user associated with the account and transaction data based on an aggregate of transactions with multiple, distinct entities;
receiving a selection of at least a subset of the universal profile to be shared with an entity;
providing the at least a subset of the universal profile to the entity in response to receiving the selection; and
receiving, from the entity, a transaction context comprising at least a portion of a transaction customized based on the at least a subset of the universal profile shared with the entity.

2. The computer system as in claim 1, wherein receiving a selection of at least a subset of the universal profile to be shared with an entity comprises:
receiving a selection of a category of transactions; and
receiving a preference to share the at least a subset of the universal profile with an entity that offers transactions included in the category of transactions.

3. The computer system as in claim 1, wherein providing the at least a subset of the universal profile to the entity comprises:
providing the at least a subset of the universal profile to an entity different than the any of the multiple, distinct entities involved in transactions upon which the at least a subset of the universal profile is based.

4. The computer system as in claim 3, wherein receiving, from the entity, a transaction context comprising at least a portion of a transaction customized based on at least the subset of the universal profile comprises:
receiving at least a portion of a transaction customized by the different entity to be similar to at least one transaction upon which the at least a subset of the universal profile is based.

5. The computer system as in claim 3, wherein receiving, from the entity, a transaction context comprising at least a portion of a transaction customized based on at least the subset of the universal profile comprises:
receiving at least a portion of a transaction customized by the entity according to an inference about at least one transaction upon which the at least a subset of the universal profile is based.

6. The computer system as in claim 3, wherein receiving, from the entity, a transaction context comprising at least a portion of a transaction customized based on at least the subset of the universal profile comprises
receiving a listing comprising a plurality of transaction attributes identified by the entity based on a presence of at least one attribute of the at least a subset of the universal profile;
wherein the computer system further performs operations comprising:
receiving a selection of a portion of the plurality of transaction attributes; and
initiating a transaction based on the selected transaction attributes.

7. A computer-implemented method comprising:
receiving a selection of at least a subset of the universal profile to be shared with an entity;
providing the at least a subset of the universal profile to the entity in response to receiving the selection; and
receiving, from the entity, a transaction context comprising at least a portion of a transaction customized based on the at least a subset of the universal profile shared with the entity.

8. The computer-implemented method as in claim 7, wherein receiving a selection of at least a subset of the universal profile to be shared with an entity comprises:
receiving a selection of a category of transactions; and
receiving a preference to share the at least a subset of the universal profile with an entity that offers transactions included in the category of transactions.

9. The computer-implemented method as in claim 7, wherein providing the at least a subset of the universal profile to the entity comprises:
providing the at least a subset of the universal profile to an entity different than the any of the multiple, distinct entities involved in transactions upon which the at least a subset of the universal profile is based.

10. The computer-implemented method as in claim 9, wherein receiving, from the entity, a transaction context comprising at least a portion of a transaction customized based on at least the subset of the universal profile comprises:
receiving at least a portion of a transaction customized by the different entity to be similar to at least one transaction upon which the at least a subset of the universal profile is based.

11. The computer-implemented method as in claim 9, wherein receiving, from the entity, a transaction context comprising at least a portion of a transaction customized based on at least the subset of the universal profile comprises:
receiving at least a portion of a transaction customized by the entity according to an inference about at least one transaction upon which the at least a subset of the universal profile is based.

12. The computer-implemented method as in claim 9, wherein receiving, from the entity, a transaction context comprising at least a portion of a transaction customized based on at least the subset of the universal profile comprises
receiving a listing comprising a plurality of transaction attributes identified by the entity based on a presence of at least one attribute of the at least a subset of the universal profile;
wherein the computer system further performs operations comprising:
receiving a selection of a portion of the plurality of transaction attributes; and
initiating a transaction based on the selected transaction attributes.

13. A non-transitory computer-readable medium comprising instructions executable by one or more processors to cause the one or more processors to perform operations comprising:
receiving a selection of at least a subset of the universal profile to be shared with an entity;
providing the at least a subset of the universal profile to the entity in response to receiving the selection; and
receiving, from the entity, a transaction context comprising at least a portion of a transaction customized based on the at least a subset of the universal profile shared with the entity.

14. The non-transitory computer-readable medium as in claim 13, wherein receiving a selection of at least a subset of the universal profile to be shared with an entity comprises:
receiving a selection of a category of transactions; and
receiving a preference to share the at least a subset of the universal profile with an entity that offers transactions included in the category of transactions.

15. The non-transitory computer-readable medium as in claim 13, wherein providing the at least a subset of the universal profile to the entity comprises:
providing the at least a subset of the universal profile to an entity different than the any of the multiple, distinct entities involved in transactions upon which the at least a subset of the universal profile is based.

16. The non-transitory computer-readable medium as in claim 15, wherein receiving, from the entity, a transaction context comprising at least a portion of a transaction customized based on at least the subset of the universal profile comprises:
receiving at least a portion of a transaction customized by the different entity to be similar to at least one transaction upon which the at least a subset of the universal profile is based.

17. The non-transitory computer-readable medium as in claim 15, wherein receiving, from the entity, a transaction context comprising at least a portion of a transaction customized based on at least the subset of the universal profile comprises:
receiving at least a portion of a transaction customized by the entity according to an inference about at least one transaction upon which the at least a subset of the universal profile is based.

18. The non-transitory computer-readable medium as in claim 15, wherein receiving, from the entity, a transaction context comprising at least a portion of a transaction customized based on at least the subset of the universal profile comprises
receiving a listing comprising a plurality of transaction attributes identified by the entity based on a presence of at least one attribute of the at least a subset of the universal profile;
wherein the computer system further performs operations comprising:
receiving a selection of a portion of the plurality of transaction attributes; and
initiating a transaction based on the selected transaction attributes.

19. The non-transitory computer-readable medium as in claim 13, wherein providing the at least a subset of the universal profile to the entity in response to receiving the selection comprises:
sending the at least a subset of the universal profile to the entity based on a computing device associated with the universal profile detecting a computing device associated with the entity.

20. The non-transitory computer-readable medium as in claim 19, wherein
sending the at least a subset of the universal profile to the entity comprises:
sending the at least a subset of the universal profile to the entity based on the computing device associated with the universal profile detecting the computing device associated with the entity being within a predetermined distance of each other.
